(19) United States
(12) Patent Application Publication
(10) Pub. No.: US 2024/0420221 A1
(43) Pub. Date: Dec. 19, 2024

(54) ORDER PROCESSING METHOD AND APPARATUS

(71) Applicant: Beijing Wodong Tianjun Information Technology Co., Ltd., Beijing (CN)

(72) Inventor: Ningxuan KANG, Beijing (CN)

(21) Appl. No.: 18/690,665

(22) PCT Filed: Aug. 24, 2022
(86) PCT No.: PCT/CN2022/114466

§ 371 Date: Mar. 8, 2024

(30) Foreign Application Priority Data
Sep. 15, 2021 (CN) 202111079045.9

(51) Int. Cl. G06Q 30/0601; G06Q 10/087

(52) U.S. Cl. CPC G06Q 30/0635; G06Q 10/087

(57) ABSTRACT

Disclosed in embodiments of the present disclosure are an order processing method and apparatus. An embodiment of the method comprises: obtaining content association information of orders in a set of orders to be processed, wherein the content association information is used for representing whether different orders comprise the same service content; respectively determining, according to the content association information, backlog influence degrees of the orders in the set of the orders to be processed, wherein the backlog influence degree of the order represents the influence degree of the order on the backlog state of the orders in the set of the orders to be processed; and determining, according to the backlog influence degrees, a processing order of the orders in the set of the orders to be processed, and performing order processing according to the determined processing order.

### CROSS-REFERENCE TO RELATED APPLICATIONS

This patent application is a national stage of International Application No. PCT/CN2022/114466, filed on Aug. 24, 2022, which claims the benefit of priority to Chinese Patent Application No. 202111079045.9, filed on Sep. 15, 2021. Both of the aforementioned applications are hereby incorporated by reference in their entirety.

### TECHNICAL FIELD

Embodiments of the present disclosure relate to the field of computer technology, in particular to a method and apparatus for processing an order.

### BACKGROUND

With the rapid development of e-commerce and logistics, more and more users conduct transactions of various services online via the Internet. For example, purchasing goods and a variety of life services. With the increasing number of user transaction orders, for e-commerce platforms, how to design rational and efficient order fulfillment policy is one of the issues that need to be studied.

Order fulfillment policy refers to a processing process staring from the time a user submits an order to completion of the order in service content preparation. Taking a user's purchase of goods as an example, the order fulfillment policy includes the processing process starting from the time the user submits an order to the completion of order picking in a corresponding warehouse, specifically including order service content analysis, order process control, inventory matching of items involved in the order, and so on. The order fulfillment policy directly determines an overall processing of all to-be-processed orders, and therefore has a significant impact on an overall order processing efficiency.

Existing order fulfillment policy typically accumulates orders generated within a certain time period (e.g., within 10 minutes) and then process the orders in batches. Generally, e-commerce platforms may be based on the “first-come-first-served” rule to ensure that orders accumulated in the same batch may be processed according to their generation time, and prioritize the processing of orders generated earlier in the case of limited inventory.

### SUMMARY

Embodiments of the present disclosure propose a method and apparatus for processing an order.

One or more embodiments of the present disclosure provides a method for processing an order. The method including: acquiring content association information between orders in a set of to-be-processed orders, where the content association information is used for representing whether different orders include a same service content: respectively determining, based on the content association information, backlog influence degrees of the orders in the set of to-be-processed orders, wherein a backlog influence degree of an order represents an influence degree of the order on a backlog state of the orders in the set of to-be-processed orders; and determining, based on the backlog influence degrees, a processing sequence of the orders in the set of to-be-processed orders, and performing order processing according to the determined processing sequence.

One or more embodiments of the present disclosure provides an apparatus for processing orders. The apparatus includes: an acquisition unit, configured to acquire content association information between orders in a set of to-be-processed orders, wherein the content association information is used for representing whether different orders comprise a same service content: a determination unit, configured to respectively determine, based on the content association information, backlog influence degrees of the orders in the set of to-be-processed orders, wherein a backlog influence degree of an order represents an influence degree of the order on a backlog state of the orders in the set of to-be-processed orders; and a processing unit, configured to determine, based on the backlog influence degrees, a processing sequence of the orders in the set of to-be-processed orders, and perform order processing according to the determined processing sequence.

One or more embodiments of the present disclosure provides an electronic device. The electronic device includes: one or more processors; and a storage apparatus, storing one or more programs thereon, the one or more programs, when executed by the one or more processors, cause the one or more processors to implement the method for processing orders according to the first aspect.

One or more embodiments of the present disclosure provides a computer readable storage medium, storing a computer program thereon, wherein, the program, when executed by a processor, implements the method for processing orders according to the first aspect.

### BRIEF DESCRIPTION OF THE DRAWINGS

Other features, objectives and advantages of the present disclosure will become more apparent by reading the detailed description of non-limiting embodiments with reference to the following accompanying drawings:

FIG. 1 is an example system architecture diagram to which embodiments of the present disclosure may be applied;

FIG. 2 is a flowchart of a method for processing an order according to an embodiment of the present disclosure;

FIG. 3 is a flowchart of an embodiment of determining a preceding order set and a succeeding order set of each order;

FIG. 4 is a flowchart of an embodiment of determining a backlog influence degree of the orders:

FIG. 5 is a flowchart of the method for processing an order according to another embodiment of the present disclosure;

FIG. 6 is a schematic diagram of an application scenario of the method for processing an order according to an embodiment of the present disclosure:

FIG. 7 is a schematic structural diagram of an apparatus for processing an order according to an embodiment of the present disclosure; and

FIG. 8 is a schematic structural diagram of an electronic device suitable for implementing embodiments of the present disclosure.

### DETAILED DESCRIPTION OF EMBODIMENTS

Embodiments of the present disclosure is described in further detail below in connection with the accompanying drawings. It may be understood that the embodiments described herein are only for the purpose of explaining the relevant disclosure, and are not a limitation of the disclosure. It should also be noted that, for ease of description, only parts related to the relevant disclosure are shown in the accompanying drawings.

It should be noted that the embodiments and features in embodiments of the present disclosure may be combined with each other on a non-conflict basis. Embodiments of the present disclosure will be described in detail below with reference to the accompanying drawings.

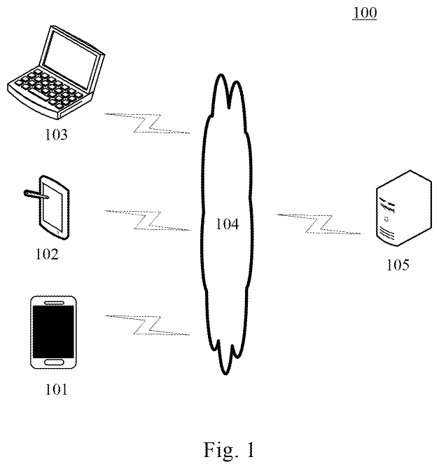

FIG. 1 illustrates an example architecture 100 to which a method for processing an order or an apparatus for processing an order of embodiments of the present disclosure may be applied.

As shown in FIG. 1, the system architecture 100 may include terminal device(s) 101, 102, 103, a network 104, and a server 105. The network 104 serves as a medium providing a communication link between the terminal device(s) 101, 102, 103, and the server 105. The network 104 may include various types of connections, such as wired, wireless communication links or optical fibers.

The terminal device(s) 101, 102, 103 interact with the server 105 via the network 104 to receive or send messages or the like. Various client applications may be installed on the terminal device(s) 101, 102, 103. For example, browser applications, search applications, instant messaging tools, shopping applications, service platforms or tools, or the like.

The terminal device(s) 101, 102, 103 may be hardware or software. When the terminal device(s) 101, 102, 103 are hardware, they may be various electronic devices, including but not limited to smartphones, tablet computers, e-book readers, laptop computers and desktop computers, or the like. When the terminal device(s) 101, 102, 103 are software, they may be installed in the electronic devices listed above. The terminal devices may be implemented as multiple software or software modules (e.g., multiple software or software modules for providing distributed services), or as a single software or software module, which is not limited herein.

The server 105 may be a server providing various services, such as a server providing back-end support for client applications installed on the terminal device(s) 101, 102, 103. The server 105 may acquire, based on to-be-processed orders submitted by the terminal device(s) 101, 102, 103, content association information between these orders, and determine backlog influence degrees of the orders based on the content association information, then determine processing sequences of the orders based on the backlog influence degrees, and perform order processing according to the determined processing sequences.

It should be noted that the method for processing an order provided by embodiments of the present disclosure is generally performed by the server 105, and accordingly, the apparatus for processing an order is generally provided in the server 105.

It should also be noted that an order processing application may also be installed in the terminal device(s) 101, 102, 103. The terminal device(s) 101, 102, 103 may also process orders in a set of to-be-processed orders based on the order processing application. In this regard, the method for processing an order may also be performed by the terminal device(s) 101, 102, 103, and accordingly, the apparatus for processing an order may also be provided in the terminal device(s) 101, 102, 103. In this regard, the example system architecture 100 may not include the server 105 and the network 104.

It should be noted that the server 105 may be hardware or software. When the server 105 is hardware, it may be implemented as a distributed server cluster consisting of multiple servers, or as a single server. When the server 105 is software, it may be implemented as multiple software or software modules (e.g., multiple software or software modules for providing distributed services), or as a single software or software module, which is not limited herein.

It should be understood that the number of terminal devices, networks, and servers in FIG. 1 is only illustrative. Depending on implementation needs, there may be any number of terminal devices, networks, and servers.

With further reference to FIG. 2, illustrating a flow 200 of a method for processing an order according to an embodiment of the present disclosure. The method for processing an order includes the following steps:

Step 201, acquiring content association information between orders in a set of to-be-processed orders.

In the present embodiment, the order may be any type of order. Correspondingly, service contents in an order may be various. A service content in the order may refer to a service provided by the order. For example, the service contents of the order may include provision of various items or provision of various services. The set of to-be-processed orders may be composed of a number of to-be-processed orders. The to-be-processed orders may be any orders. For example, the set of to-be-processed orders may be composed of orders generated within the last 10 minutes.

For any two orders, the content association information between the orders may be used for indicating whether the two orders include a same service content. It should be noted that each order may include a plurality of service content items, and if the two orders include at least one same service content item, it may be considered that the two orders include a same service content.

For example, order “A” includes items “X” and “Y”, and order “B” includes items “X” and “Z”. Since the orders “A” and “B” include the same item “X”, it may be considered that the orders “A” and “B” include the same service content.

The content association information between the orders in the set of to-be-processed orders may include the content association information between any two orders. The content association information between the orders may be determined based on the service contents included in the orders.

An executing body for processing an order (such as the server 105 shown in FIG. 1) may acquire the content association information between the orders in the set of to-be-processed orders from a local device or other storage devices. The content association information between the orders may be generated by the executing body or by other electronic devices.

Step 202, respectively determining, based on the content association information of the orders, backlog influence degrees of the orders in the set of to-be-processed orders.

In the present embodiment, an order backlog state may refer to a situation where orders are backlogged and cannot be processed timely. The backlog influence degree of an order may indicate a degree of influence of the order on the order backlog state of the set of to-be-processed orders. In particular, the backlog influence degree of an order may represent the extent of a possible order backlog situation due to non-execution of the order.

Generally, the orders need to be executed sequentially according to the generation times of the orders, and in the case of limited inventory, prioritize the processing of an order which is generated earlier. The generation time of an order may refer to the time when a user places the order. Therefore, the generation times of orders and the content association information between the orders directly affect the processing sequence of each order. The content association information between orders is one of the fundamental reasons of the order backlog situation, and the backlog influence degrees of the orders may be determined using various methods based on actual application requirements.

For example, for an order, the number of orders that include a same service content as the order may be determined based on the content association information between the order and the other orders, and then the backlog influence degree of the order may be determined based on the determined number and the generation time of the order. Generally, the determined number is directly proportional to the backlog influence degree of the order, and the generation time is inversely proportional to the backlog influence degree of the order. As an example, for each order, a quotient of the number of orders that include a same service content as the order and the generation time may be determined as the backlog influence degree of the order.

Step 203, determining, based on the backlog influence degrees of the orders, a processing sequence of the orders in the set of to-be-processed orders, and performing order processing according to the determined processing sequence.

In the present embodiment, after obtaining the backlog influence degrees respectively corresponding to the orders, the processing sequence of the orders may be further determined, and then the processing of the orders may be completed sequentially according to the determined processing sequence. Generally, the orders in the set of to-be-processed orders may be sorted according to the corresponding backlog influence degrees in descending order, and the obtained sequence may be used as the processing sequence of the orders.

Here, the process of order processing may be set flexibly according to an actual application scenario. For example, the process of order processing may include processes such as packing, sorting, and shipping of the items involved in the orders.

In some alternative implementations of the present embodiment, the backlog influence degree of each order in the set of to-be-processed orders may be used for representing the number of associated orders of the each order in the set of to-be-processed orders. In particular, for each order, the associated orders of the order in the set of to-be-processed orders may constitute an associated order set of the order, and correspondingly, non-associated orders of the order in the set of to-be-processed orders may constitute a non-associated order set of the order.

Service contents of all the associated orders in the associated order set of the order may not intersect with service contents of all the non-associated orders in the non-associated order set of the order. That is, none of the service contents covered by the associated order set of the order is in the service contents covered by the non-associated order set of the order. For each order, the associated order set and the non-associated order set of each order may be selected based on the content association information of the orders in the set of to-be-processed orders.

The associated orders of each order thus determined may include all orders associated with the order by way of cascading, therefore, an execution state of each order may directly influence the backlog of its associated orders. Thus, based on the number of associated orders of an order to determine the backlog influence degree of the order allows for a more accurate assessment of the extent of order backlog that may result from the order, which in turn facilitates subsequent rational arrangement of the order in the processing sequence, so as to avoid serious backlog of orders as far as possible.

In some alternative implementations of the present embodiment, for each order in the set of to-be-processed orders, a preceding order set and a succeeding order set of the order may be determined based on the content association information of the orders.

Each order includes a same service content as orders in its preceding order set, respectively, and each order is generated no earlier than the orders in its preceding order set. Each order and each order in its preceding order set may include at least one same service content. The same service content included in each order and the orders in its preceding order set, respectively, may be the same or different.

At the same time, each order also includes a same service content as orders in its succeeding order set, respectively, and an order is generated no later than the orders in its succeeding order set. Each order and each order in its succeeding order set may include at least one same service content. The same service contents shared by each order and the various orders in its succeeding order set, respectively, may be the same or different.

In particular, the preceding order set and the succeeding order set of each order may be statistically determined based on the content association information of the orders and the generation times of the orders.

As an example, order “A” includes items “01”, “02” and “03”, order “B” includes items “02” and “04”, and order “C” includes items “02”, “03” and “05”, and order “A” is generated prior to order “B” and order “B” is generated prior to order “C”. Then, for order “A”, its preceding order set is empty, and its succeeding order set includes orders “B” and “C”. For order “B”, its preceding order set includes order “A”, and its succeeding order set includes order “C”. For order “C”, its preceding order set includes orders “A” and “B”, and its succeeding order set is empty.

Generally, each order has corresponding association relationships with the orders in its preceding order set and succeeding order set. For example, if order “X” is a preceding order to order “Y”, then order “Y” must also be a succeeding order to order “X”.

By analysing the preceding order set and the succeeding order set of each order, it is possible to get a clearer and more intuitive understanding of content associations between the orders, thus facilitating a subsequent analysis of the backlog influence degrees of the orders, so as to rationally design the processing sequence of the orders.

In the existing technology, in order to ensure the “first-come-first-served” order processing rule, usually order processing is performed sequentially and strictly according to the generation times of the orders, however, in the case of a large number of orders and severe content association between orders processed in one batch (such as scenarios where certain items are on sale), a single unprocessed order may result in a large number of subsequent associated orders being unprocessed, leading to a serious order backlog.

In response to this problem, the method provided in the above embodiment of the present disclosure, by analyzing the content association information between the orders, and determining the backlog influence degrees of the orders based on this, to understand the degree of influence of each order on the order backlog situation of the set of to-be-processed orders respectively, then rationally arranging the processing sequence of the orders based on the backlog influence degrees of the orders, and prioritizing timely processing of to-be-processed orders that may result in serious backlog of orders, serious order backlog may be avoided, and an order processing efficiency and resource utilization may be improved.

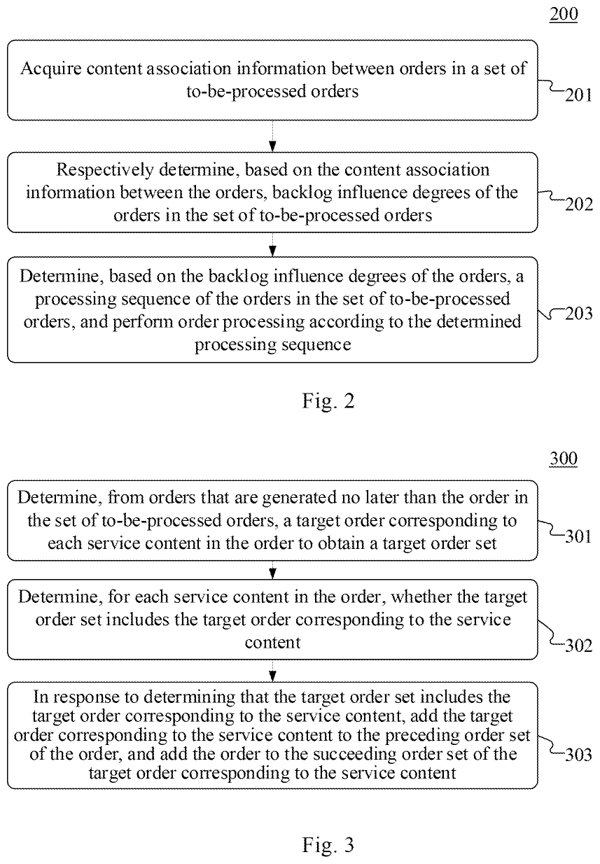

With further reference to FIG. 3, illustrating a flow 300 of an embodiment of determining a preceding order set and a succeeding order set of each order. The flow 300 includes the following steps:

Step 301, determining, from orders that are generated no later than the order in the set of to-be-processed orders, a target order corresponding to each service content in the order to obtain a target order set.

In the present embodiment, for each order in the set of to-be-processed orders, the orders that are generated no later than the order may first be selected from the to-be-processed orders to obtain a subset of orders. Then, for each service content included in the order, the target order corresponding to the service content may be selected from the subset of orders obtained in this step, so as to obtain the target order set composed of target orders respectively corresponding to the service contents included in the order.

Here, the target order corresponding to each service content may be the order including the service content and has the latest generation time. In particular, for each service content, orders including the service content may first be selected from the subset of orders obtained in this step, and then the order having the latest generation time may be selected as the target order corresponding to the service content from these selected orders.

Step 302, determining, for each service content in the order, whether the target order set includes the target order corresponding to the service content.

In the present embodiment, for each service content included in the order, it may be determined whether the target order set includes the target order corresponding to the service content. Since there is a situation in which none of the orders in the subset of orders obtained in the previous step 301 include a certain service content included in the order, in this regard, there is no corresponding target order for the certain service content.

Step 303, in response to determining that the target order set includes the target order corresponding to the service content, adding the target order corresponding to the service content to the preceding order set of the order, and adding the order to the succeeding order set of the target order corresponding to the service content.

In the present embodiment, for each service content, if the target order corresponding to the service content is included in the target order set, the target order corresponding to the service content is added to the preceding order set of the order, and at the same time the order is added to the succeeding order set of the target order corresponding to the service content.

Execution processes not described in the present embodiment may refer to relevant descriptions in the above embodiments, detailed description thereof will be omitted.

Based on this, according to the natural sequence of generation times of the orders in the set of to-be-processed orders, the preceding order sets and the succeeding order sets of the orders are sequentially determined or updated, until the finally determined preceding order sets and succeeding order sets corresponding to the orders are respectively obtained, therefore, it is possible to orderly and timely determine the latest preceding order set and succeeding order set of each order, so as to facilitate the subsequent analysis and setup of the order processing sequence. In the event that there are a large number of same service contents in the orders in the set of to-be-processed orders, order processing time can be effectively shortened, thereby improving the order processing efficiency.

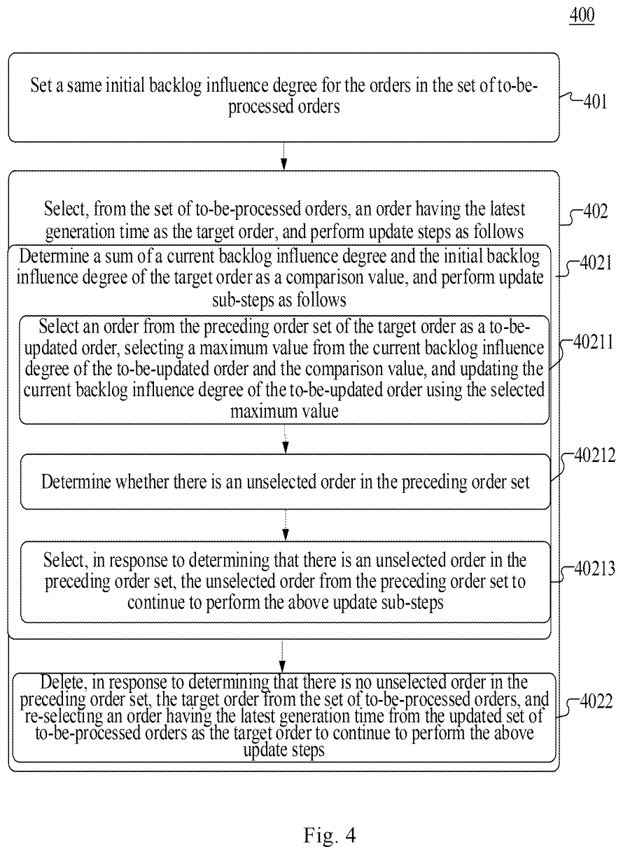

With further reference to FIG. 4, illustrating a flow 400 of an embodiment of determining a backlog influence degree of the orders. The flow 400 includes the following steps:

Step 401, setting a same initial backlog influence degree for the orders in the set of to-be-processed orders.

In the present embodiment, the initial backlog influence degree may be flexibly set by those skilled in the art in advance according to an actual application scenario. Generally, the initial backlog influence degree is not less than zero. For example, the initial backlog influence degree may be set to 1 for all orders.

Step 402, selecting, from the set of to-be-processed orders, an order having the latest generation time as the target order, and performing update steps 4021-4022 as follows:

Step 4021, determining a sum of a current backlog influence degree and the initial backlog influence degree of the target order as a comparison value, and performing update sub-steps 40211-40213 as follows:

In this step, the sum of the current latest backlog influence degree and the initial backlog influence degree of the target order may be calculated and used as the comparison value.

Step 40211, selecting an order from the preceding order set of the target order as a to-be-updated order, selecting a maximum value from the current backlog influence degree of the to-be-updated order and the comparison value, and updating the current backlog influence degree of the to-be-updated order using the selected maximum value.

In this step, the order may be flexibly selected from the preceding order set of the target order as the to-be-updated order. For example, the order may be selected randomly or sequentially according to the generation time.

After selecting the to-be-updated order, the current latest backlog influence degree of the to-be-updated order and the comparison value obtained in the above step 4021 may be compared, to select the maximum value therefrom, then the maximum value may be used to update the current backlog influence degree of the to-be-updated order, i.e., the maximum value may be used as the current latest backlog influence degree of the to-be-updated order.

Step 40212, determining whether there is an unselected order in the preceding order set.

Step 40213, selecting, in response to determining that there is an unselected order in the preceding order set, the unselected order from the preceding order set to continue to perform the above update sub-steps.

In this step, if there is an unselected order in the preceding order set, an order is re-selected from the unselected order in the preceding order set to continue to perform the above update sub-steps until there is no unselected order in the preceding order set.

Step 4022, deleting, in response to determining that there is no unselected order in the preceding order set, the target order from the set of to-be-processed orders, and re-selecting an order having the latest generation time from the updated set of to-be-processed orders as the target order to continue to perform the above update steps.

In this step, if there is no unselected order in the preceding order set, the target order is deleted from the set of to-be-processed orders to update the set of to-be-processed orders, and then the order having the latest generation time is re-selected in the updated set of to-be-processed orders as the target order, to continue to perform the above update steps until the set of to-be-processed orders after the update is empty.

As an example, the initial backlog influence degrees of the orders in the set of to-be-processed orders may be initialized as 1, then an order sequence may be formed in order of generation times from late to early, and orders are selected in sequence from the order sequence for traversal. For each selected order “X”, preceding orders in the preceding order set are traversed, and for each preceding order “Y”, the backlog influence degree of the order “Y” may be updated to be D (Y)=max (D (Y), D (X)+1), and the operation is then repeated until all orders in the order sequence have been traversed, that is, the finally determined backlog influence degrees of the orders may be obtained.

Execution processes not described in the present embodiment may refer to relevant descriptions in the above embodiments, detailed description thereof will be omitted.

The method provided in the above embodiment of the present disclosure accurately represents the backlog influence degrees of the orders by first setting the same initial backlog influence degree for the orders, then sequentially updating the backlog influence degrees of the orders in the preceding order set of each order, in the order of generation times from late to early, so that the more the cascading preceding orders of an order, the higher its backlog influence degree, thereby ensuring that the order processing sequence subsequently determined based on the backlog influence degree is rational.

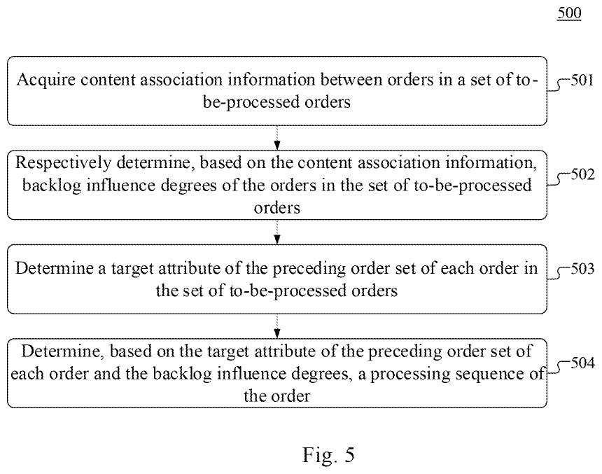

With further reference to FIG. 5, illustrating a flow 500 of another embodiment of the method for processing an order. The flow 500 of the method for processing an order includes the following steps:

Step 501, acquiring content association information between orders in a set of to-be-processed orders.

Step 502, respectively determining, based on the content association information, backlog influence degrees of the orders in the set of to-be-processed orders.

Step 503, determining a target attribute of the preceding order set of each order in the set of to-be-processed orders.

In the present embodiment, the target attribute of the preceding order set may be used for indicating whether the preceding order set is empty.

Step 504, determining, based on the target attribute of the preceding order set of each order and the backlog influence degrees, a processing sequence of the order.

In the present embodiment, various methods may be used flexibly to determine the processing sequence of the order, based on the target attribute of the preceding order set of each order and the backlog influence degree.

If there is a preceding order for an order, it indicates that the order needs to be processed after its preceding order has been processed in order to ensure that inventory is allocated to the order first. Therefore, an order having an empty preceding order set may be processed in an earlier order than orders having a non-empty preceding order set.

The higher the backlog influence degree of an order, the more severe the order backlog may be caused by the order. Therefore, in order to avoid a serious backlog of orders, priority should be given to the order having a high backlog influence degree, so that the order having a high backlog influence degree may be processed earlier than an order having a low backlog influence degree.

Thus, the processing sequence of the orders in the set of to-be-processed orders may be rationally assigned to ensure that inventory can be prioritized and allocated to orders having an earlier generation time, at the same time, it may ensure that the orders having a high backlog influence degree are prioritized to avoid serious order backlog.

In some alternative implementations of the present embodiment, the determining, based on the backlog influence degrees of the orders, a processing sequence of the orders in the set of to-be-processed orders, and performing order processing according to the determined processing sequence, may be performed through the following steps:

Step one, selecting an order having an empty preceding order set from the set of to-be-processed orders and add the selected order to an order processing queue, and performing processing steps two to four as follows:

In this step, it may be first determined whether the preceding order sets of the orders in the set of to-be-processed orders are empty, and the order having an empty preceding order set may be selected from the set of to-be-processed orders and is added to the order processing queue.

Step two, in response to determining that the order processing queue is non-empty and there is a current idle thread, selecting an order having the highest backlog influence degree from the order processing queue as a candidate order, processing the selected candidate order using the idle thread, and deleting the candidate order from the order processing queue.

In this step, threads may be allocated for processing orders. If there are orders in the order processing queue and there is a current idle thread that is capable of processing an order, the order having the highest backlog influence degree may be prioritized from the order processing queue and selected as the candidate order, and then the idle thread may be used to process the order having the highest backlog influence degree. Then, the candidate order that has begun to be processed may be deleted from the order processing queue.

Step three, in response to determining that the processing of the candidate order is completed, releasing the occupied thread, and deleting an association relationship between the candidate order and the orders in the succeeding order set of the candidate order.

In this step, if the processing of the candidate order is completed, the occupied thread may be released to make the thread idle. At the same time, since the candidate order has been processed, it may not cause backlog of other orders, so that in this regard, the association relationship between the candidate order and the orders in its succeeding order set may be deleted. In particular, the succeeding order set of the processed candidate order may be deleted, at the same time, for an order in its succeeding order set, the processed candidate order may be deleted from the preceding order set of the order.

Step four, in response to determining that the set of to-be-processed orders includes an unprocessed order, updating the order processing queue to continue to perform the above processing steps.

In this step, if the set of to-be-processed orders still includes an unprocessed order, an order having an empty preceding order set may be selected from the set of to-be-processed orders and is added to the order processing queue, to update the order processing queue, and then based on the updated order processing queue, the execution of the above steps two to four may continue until the processing of all the to-be-processed orders is complete.

In some cases, the number of idle threads may be a plurality, in this regard, if there are a plurality of orders having empty preceding order sets, the plurality of orders may be processed in parallel using the plurality of idle threads at the same time, in order to further improve the order processing efficiency and thread utilization.

Execution processes not described in the present embodiment may refer to relevant descriptions in the above embodiments, detailed description thereof will be omitted.

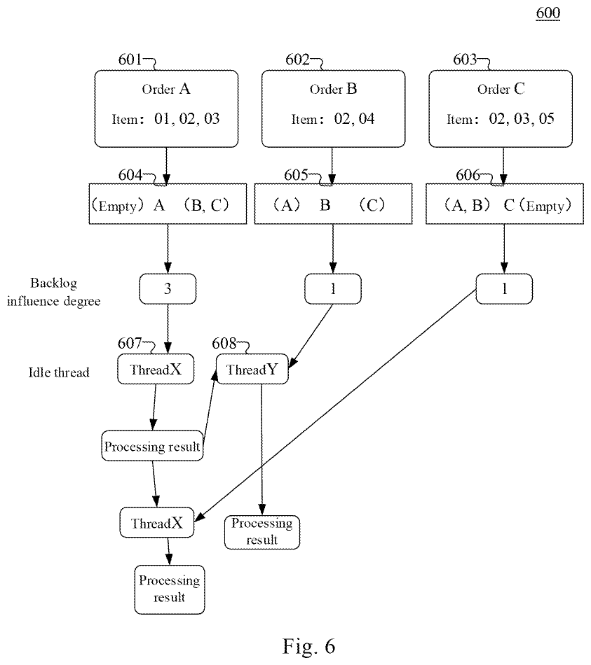

With further reference to FIG. 6, FIG. 6 is a schematic application scenario 600 of the method for processing an order according to an embodiment of the present embodiment. In the application scenario of FIG. 6, orders submitted by users within the last 5 minutes may be acquired to form a set of to-be-processed orders, including order “A” 601, order “B” 602, and order “C” 603. Here, order “A” includes items “01”, “02” and “03”, order “B” includes items “02” and “04”, and order “C” includes items “02”, “03” and “05”. In addition, order “A” is generated before order “B”, and order “B” is generated before order “C”.

For order “A”, as shown by label 604 in the figure, its preceding order set is empty and its succeeding order set includes orders “B” and “C”. For order “B”, as shown by label 605 in the figure, its preceding order set includes order “A” and its succeeding order set includes order “C”. For order “C”, as shown by label 606 in the figure, its preceding order set includes orders “A” and “B”, and its succeeding order set is empty. Based on this, the backlog influence degree of order “A” is calculated as 3, and the backlog influence degree of order “B” and order “C” is calculated as 1.

In this regard, the idle threads are thread “X” 607 and thread “Y” 608. Since there is no preceding order for order “A”, first, thread “X” 607 may be randomly selected to process order “A” to obtain a corresponding processing result, and then thread “X” may be released.

After order “A” is processed, there is no preceding order for order “B” and order “C”, so the current idle thread “X” may be used to process order “C”, and at the same time, the idle thread “Y” may be used to process order “B”, so that processing results corresponding to order “B” and order “C” may be obtained respectively.

Some existing order processing methods cache orders having the same service content as the order currently being processed by designing an order caching mechanism. However, since the capacity of a cache area is usually limited, the order processing efficiency may be greatly reduced when the cache area is saturated, while the method provided in above embodiments of the present disclosure prioritizes an order having an empty preceding order set and a high backlog influence degree by combining whether the preceding order set of each order is empty, after obtaining the backlog influence degrees of the orders in the set of to-be-processed orders, in order to avoid serious order backlog due to these orders not being processed in time, to ensure reasonableness of the order processing sequence, improving the resource utilization.

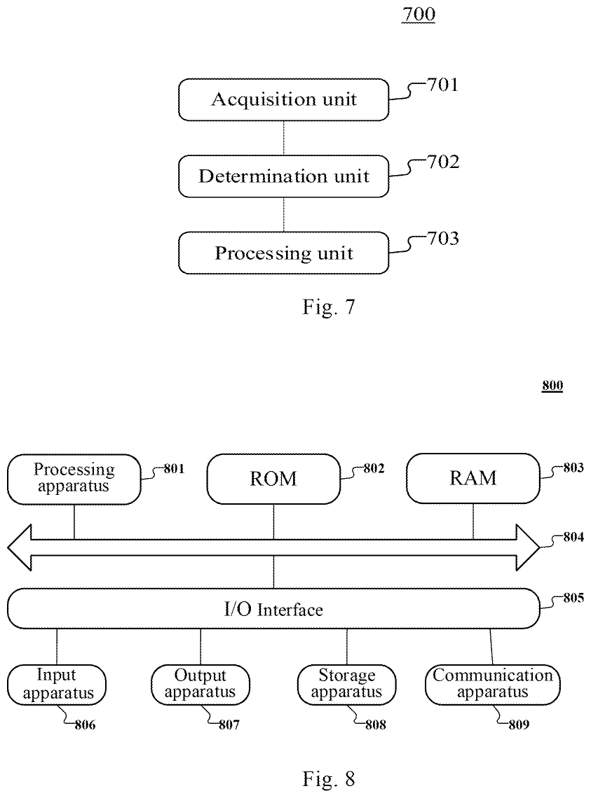

With further reference to FIG. 7, as an implementation of the method shown in the above figures, an embodiment of the present disclosure provides an apparatus for processing an order, the embodiment of the apparatus corresponds to the embodiment of the method shown in FIG. 2, and the apparatus may be applied in various electronic devices.

As shown in FIG. 7, the apparatus 700 for processing orders provided in the present embodiment includes an acquisition unit 701, a determination unit 702 and a processing unit 703. The acquisition unit 701 is configured to acquire content association information between orders in a set of to-be-processed orders, where the content association information is used for representing whether different orders comprise a same service content. The determination unit 702 is configured to respectively determine, based on the content association information, backlog influence degrees of the orders in the set of to-be-processed orders, wherein a backlog influence degree of an order represents an influence degree of the order on a backlog state of the orders in the set of to-be-processed orders. The processing unit 703 is configured to determine, based on the backlog influence degrees, a processing sequence of the orders in the set of to-be-processed orders, and performing order processing according to the determined processing sequence.

In the present embodiment, in the apparatus 700 for processing orders: for the detailed processing and technical effects of the acquisition unit 701, the determination unit 702 and the processing unit 703, reference may be made to the relevant descriptions of step 201, step 202 and step 203 in the corresponding embodiment of FIG. 2, respectively, detailed description thereof will be omitted.

In some alternative implementations of the present embodiment, a backlog influence degree of an order in the set of to-be-processed orders is used for characterizing a number of associated orders of the order in the set of to-be-processed orders, wherein service contents in an associated order of the order and service contents in a non-associated order of the order in the set of to-be-processed orders have no intersection.

In some alternative implementations of the present embodiment, the determination unit 702 is further configured to: for each order in the set of to-be-processed orders, determine, based on the content association information, a preceding order set and a succeeding order set of the order, where the order, orders in the preceding order set, and orders in the succeeding order set have the same service content, respectively, and the order is generated no earlier than the orders in the preceding order set and no later than the orders in the succeeding order set.

In some alternative implementations of the present embodiment, the determination unit 702 is further configured to: determine, from orders that are generated no later than the order in the set of to-be-processed orders, a target order corresponding to each service content in the order to obtain a target order set, where a target order corresponding to a service content is an order comprising the service content and has the latest generation time: determine, for each service content in the order, whether the target order set comprises the target order corresponding to the service content; and in response to determining that the target order set comprises the target order corresponding to the service content, add the target order corresponding to the service content to the preceding order set of the order, and add the order to a succeeding order set of the target order corresponding to the service content.

In some alternative implementations of the present embodiment, the determination unit 702 is further configured to: set a same initial backlog influence degree for the orders in the set of to-be-processed orders: select, from the set of to-be-processed orders, an order having the latest generation time as the target order, and performing update steps as follows: determining a sum of a current backlog influence degree and the initial backlog influence degree of the target order as a comparison value, and performing update sub-steps as follows: selecting an order from the preceding order set of the target order as a to-be-updated order, selecting a maximum value from the current backlog influence degree of the to-be-updated order and the comparison value, and updating the current backlog influence degree of the to-be-updated order using the selected maximum value; determining whether there is an unselected order in the preceding order set: selecting, in response to determining that there is an unselected order in the preceding order set, the unselected order from the preceding order set to continue to perform the update sub-steps; and deleting, in response to determining that there is no unselected order in the preceding order set, the target order from the set of to-be-processed orders, and re-selecting an order having the latest generation time from the updated set of to-be-processed orders as the target order to continue to perform the update steps.

In some alternative implementations of the present embodiment, the processing unit 703 is further configured to: determine a target attribute of a preceding order set of each order in the set of to-be-processed orders, wherein the target attribute is used for indicating whether the preceding order set is empty; and determine, based on the target attribute of the preceding order set of each order and the backlog influence degree of each order, a processing sequence of each order, wherein an order having an empty preceding order set is processed earlier than an order having a non-empty preceding order set, and an order having a high backlog influence degree is processed earlier than an order having a low backlog influence degree.

In some alternative implementations of the present embodiment, the processing unit 703 is further configured to: select an order having an empty preceding order set from the set of to-be-processed orders and adding the selected order to an order processing queue, and performing processing steps as follows: in response to determining that the order processing queue is non-empty and there is a current idle thread, selecting an order having the highest backlog influence degree from the order processing queue as a candidate order, processing the candidate order using the idle thread, and deleting the candidate order from the order processing queue: releasing the occupied thread in response to determining that the processing of the candidate order is completed, and deleting an association relationship between the candidate order and the orders in the succeeding order set of the candidate order; and updating, in response to determining that the set of to-be-processed orders comprises an unprocessed order, the order processing queue to continue to perform the processing steps.

The apparatus provided in the above embodiment of the present disclosure, in which the acquisition unit acquires content association information of orders in a set of to-be-processed orders, where the content association information is used for representing whether different orders include a same service content: the determination unit respectively determines, based on the content association information, backlog influence degrees of the orders in the set of to-be-processed orders, where the backlog influence degree of an order represents an influence degree of the order on a backlog state of the orders in the set of to-be-processed orders; and the processing unit determines, based on the backlog influence degrees, a processing sequence of the orders in the set of to-be-processed orders, and performs order processing according to the determined processing sequence, so as to ensure prioritizing the processing of orders having great impact on the overall backlog state of the orders, in order to avoid serious backlog of orders as a whole, which helps to improve the overall efficiency of order processing.

Reference is made below to FIG. 8, which illustrates a schematic structural diagram of an electronic device 800 suitable for implementing embodiments of the present disclosure (e.g., the server shown in FIG. 1). The server shown in FIG. 8 is merely an example and should not impose any limitation on the functionality and scope of use of the embodiments of the present disclosure.

As shown in FIG. 8, the electronic device 800 may include a processing apparatus (for example, a central processing unit, a graphics processor, etc.) 801, which may execute various appropriate actions and processes in accordance with a program stored in a read-only memory (ROM) 802 or a program loaded into a random access memory (RAM) 803 from a storage apparatus 808. In the RAM 803, various programs and data required for the operation of the electronic device 800 are also stored. The processing apparatus 801, the ROM 802, and the RAM 803 are connected to each other through a bus 804. An input/output (I/O) interface 805 is also connected to the bus 804.

Typically, the following apparatuses may be connected to the I/O interface 805: an input apparatus 806 including such as a touch screen, a touch pad, a key board, a mouse, a camera, a microphone, an accelerometer, or a gyroscope: an output apparatus 807 including such as a liquid crystal display (LCD), a speaker, a vibrator: the storage apparatus 808 including such as a magnetic tape, a hard disk; and a communication apparatus 809. The communication apparatus 809 may allow the electronic device 800 to perform wireless or wired communication with other devices to exchange data. Although FIG. 8 shows the electronic device 800 having various apparatuses, it should be understood that it is not required to implement or have all the illustrated apparatuses. It may alternatively be implemented or provided with more or fewer apparatuses. Each block shown in FIG. 8 may represent one apparatus, or may represent a plurality of apparatuses as needed.

In particular, according to embodiments of the present disclosure, the process described above with reference to the flow chart may be implemented in a computer software program. For example, an embodiment of the present disclosure includes a computer program product, which comprises a computer program that is hosted in a machine-readable medium. The computer program comprises program codes for executing the method as illustrated in the flow chart. In such an embodiment, the computer program may be downloaded and installed from a network via the communication portion 809, or may be installed from the storage portion 808, or may be installed from the ROM 802. The computer program, when executed by the central processing unit (CPU) 801, implements the above mentioned functionalities as defined by the methods of the present disclosure.

It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In some embodiments of the present disclosure, the computer readable storage medium may be any tangible medium containing or storing programs which can be used by a command execution system, apparatus or element or incorporated thereto. In some embodiments of the present disclosure, the computer readable signal medium may include data signal in the base band or propagating as parts of a carrier, in which computer readable program codes are carried. The propagating signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The computer readable medium may be included in the above electronic device, or a stand-alone computer readable medium not assembled into the electronic device. The computer readable medium carries one or more programs. The one or more programs, when executed by the electronic device, cause the electronic device to: acquire content association information between orders in a set of to-be-processed orders, where the content association information is used for representing whether different orders include a same service content: respectively determine, based on the content association information, backlog influence degrees of the orders in the set of to-be-processed orders, where a backlog influence degree of an order represents an influence degree of the order on a backlog state of the orders in the set of to-be-processed orders; and determine, based on the backlog influence degrees of the orders, a processing sequence of the orders in the set of to-be-processed orders, and perform order processing according to the determined processing sequence. The electronic device may be a computer, a cell phone, a PDA, etc. that can process orders, and may image display or sound display of order information.

A computer program code for executing operations in some embodiments of the present disclosure may be compiled using one or more programming languages or combinations thereof. The programming languages include object-oriented programming languages, such as Java, Smalltalk or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In the circumstance involving a remote computer, the remote computer may be connected to a user's computer through any network, including local area network (LAN) or wide area network (WAN), or may be connected to an external computer (for example, connected through Internet using an Internet service provider).

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units involved in the embodiments of the present disclosure may be implemented by means of software or hardware. The described units may also be provided in a processor, for example, may be described as: a processor including an acquisition unit, a determination unit and a processing unit. Here, the names of these units do not in some cases constitute limitations to such units themselves. For example, the processing unit may also be described as “a unit configured to determine, based on the backlog influence degrees of the orders, a processing sequence of the orders in the set of to-be-processed orders, and perform order processing according to the determined processing sequence”.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

1. A method for processing orders, the method comprising:
acquiring content association information between orders in a set of to-be-processed orders, wherein the content association information is used for representing whether different orders comprise a same service content;
respectively determining, based on the content association information, backlog influence degrees of the orders in the set of to-be-processed orders, wherein a backlog influence degree of an order represents an influence degree of the order on a backlog state of the orders in the set of to-be-processed orders; and
determining, based on the backlog influence degrees, a processing sequence of the orders in the set of to-be-processed orders, and performing order processing according to the determined processing sequence.

2. The method according to claim 1, wherein a backlog influence degree of an order in the set of to-be-processed orders is used for characterizing a number of associated orders of the order in the set of to-be-processed orders, wherein service contents in an associated order of the order and service contents in a non-associated order of the order in the set of to-be-processed orders have no intersection.

3. The method according to claim 2, wherein the method further comprises:
for each order in the set of to-be-processed orders, determining, based on the content association information, a preceding order set and a succeeding order set of the order, wherein the order, orders in the preceding order set, and orders in the succeeding order set have the same service content, respectively, and the order is generated no earlier than the orders in the preceding order set and no later than the orders in the succeeding order set.

4. The method according to claim 3, wherein the determining, based on the content association information, the preceding order set and the succeeding order set of the order, comprises:
determining, from orders that are generated no later than the order in the set of to-be-processed orders, a target order corresponding to each service content in the order to obtain a target order set, wherein a target order corresponding to a service content is an order comprising the service content and has the latest generation time;
determining, for each service content in the order, whether the target order set comprises the target order corresponding to the service content; and
in response to determining that the target order set comprises the target order corresponding to the service content, adding the target order corresponding to the service content to the preceding order set of the order, and adding the order to a succeeding order set of the target order corresponding to the service content.

5. The method according to claim 3, wherein the respectively determining, based on the content association information, the backlog influence degrees of the orders in the set of to-be-processed orders, comprises:
setting a same initial backlog influence degree for the orders in the set of to-be-processed orders;
selecting, from the set of to-be-processed orders, an order having the latest generation time as the target order, and performing update steps as follows:
determining a sum of a current backlog influence degree and the initial backlog influence degree of the target order as a comparison value, and performing update sub-steps as follows:
selecting an order from the preceding order set of the target order as a to-be-updated order, selecting a maximum value from the current backlog influence degree of the to-be-updated order and the comparison value, and updating the current backlog influence degree of the to-be-updated order using the selected maximum value;
determining whether there is an unselected order in the preceding order set;
selecting, in response to determining that there is an unselected order in the preceding order set, the unselected order from the preceding order set to continue to perform the update sub-steps; and
deleting, in response to determining that there is no unselected order in the preceding order set, the target order from the set of to-be-processed orders, and re-selecting an order having the latest generation time from the updated set of to-be-processed orders as the target order to continue to perform the update steps.

6. The method according to claim 1, wherein the determining, based on the backlog influence degrees, the processing sequence of the orders in the set of to-be-processed orders, and performing order processing according to the determined processing sequence, comprises:
determining a target attribute of a preceding order set of each order in the set of to-be-processed orders, wherein the target attribute is used for indicating whether the preceding order set is empty; and
determining, based on the target attribute of the preceding order set of each order and the backlog influence degree of each order, a processing sequence of each order, wherein an order having an empty preceding order set is processed earlier than an order having a non-empty preceding order set, and an order having a high backlog influence degree is processed earlier than an order having a low backlog influence degree.

7. The method according to claim 6, wherein the determining, based on the backlog influence degrees, the processing sequence of the orders in the set of to-be-processed orders, and performing order processing according to the determined processing sequence, comprises:
selecting an order having an empty preceding order set from the set of to-be-processed orders and adding the selected order to an order processing queue, and performing processing steps as follows:
in response to determining that the order processing queue is non-empty and there is a current idle thread, selecting an order having the highest backlog influence degree from the order processing queue as a candidate order, processing the candidate order using the idle thread, and deleting the candidate order from the order processing queue;
releasing the occupied thread in response to determining that the processing of the candidate order is completed, and deleting an association relationship between the candidate order and the orders in the succeeding order set of the candidate order; and
updating, in response to determining that the set of to-be-processed orders comprises an unprocessed order, the order processing queue to continue to perform the processing steps.

8. An apparatus for processing orders, the apparatus comprising:
one or more processors; and
a storage apparatus, storing one or more programs thereon,
the one or more programs, when executed by the one or more processors, cause the one or more processors to implement operations, the operations comprising:
acquiring content association information between orders in a set of to-be-processed orders, wherein the content association information is used for representing whether different orders comprise a same service content;
respectively determining, based on the content association information, backlog influence degrees of the orders in the set of to-be-processed orders, wherein a backlog influence degree of an order represents an influence degree of the order on a backlog state of the orders in the set of to-be-processed orders; and
determining, based on the backlog influence degrees, a processing sequence of the orders in the set of to-be-processed orders, and performing order processing according to the determined processing sequence.

9. (canceled)

10. A non-transitory computer readable storage medium, storing a computer program thereon, wherein, the program, when executed by a processor, implements operations, the operations comprising:
acquiring content association information between orders in a set of to-be-processed orders, wherein the content association information is used for representing whether different orders comprise a same service content;
respectively determining, based on the content association information, backlog influence degrees of the orders in the set of to-be-processed orders, wherein a backlog influence degree of an order represents an influence degree of the order on a backlog state of the orders in the set of to-be-processed orders; and
determining, based on the backlog influence degrees, a processing sequence of the orders in the set of to-be-processed orders, and performing order processing according to the determined processing sequence.

11. The apparatus according to claim 8, wherein a backlog influence degree of an order in the set of to-be-processed orders is used for characterizing a number of associated orders of the order in the set of to-be-processed orders, wherein service contents in an associated order of the order and service contents in a non-associated order of the order in the set of to-be-processed orders have no intersection.

12. The apparatus according to claim 11, wherein the operations further comprise:
for each order in the set of to-be-processed orders, determining, based on the content association information, a preceding order set and a succeeding order set of the order, wherein the order, orders in the preceding order set, and orders in the succeeding order set have the same service content, respectively, and the order is generated no earlier than the orders in the preceding order set and no later than the orders in the succeeding order set.

13. The apparatus according to claim 12, wherein the determining, based on the content association information, the preceding order set and the succeeding order set of the order, comprises:
determining, from orders that are generated no later than the order in the set of to-be-processed orders, a target order corresponding to each service content in the order to obtain a target order set, wherein a target order corresponding to a service content is an order comprising the service content and has the latest generation time;
determining, for each service content in the order, whether the target order set comprises the target order corresponding to the service content; and
in response to determining that the target order set comprises the target order corresponding to the service content, adding the target order corresponding to the service content to the preceding order set of the order, and adding the order to a succeeding order set of the target order corresponding to the service content.

14. The apparatus according to claim 12, wherein the respectively determining, based on the content association information, the backlog influence degrees of the orders in the set of to-be-processed orders, comprises:
setting a same initial backlog influence degree for the orders in the set of to-be-processed orders;
selecting, from the set of to-be-processed orders, an order having the latest generation time as the target order, and performing update steps as follows:
determining a sum of a current backlog influence degree and the initial backlog influence degree of the target order as a comparison value, and performing update sub-steps as follows:
selecting an order from the preceding order set of the target order as a to-be-updated order, selecting a maximum value from the current backlog influence degree of the to-be-updated order and the comparison value, and updating the current backlog influence degree of the to-be-updated order using the selected maximum value;
determining whether there is an unselected order in the preceding order set;
selecting, in response to determining that there is an unselected order in the preceding order set, the unselected order from the preceding order set to continue to perform the update sub-steps; and
deleting, in response to determining that there is no unselected order in the preceding order set, the target order from the set of to-be-processed orders, and re-selecting an order having the latest generation time from the updated set of to-be-processed orders as the target order to continue to perform the update steps.

15. The apparatus according to claim 8, wherein the determining, based on the backlog influence degrees, the processing sequence of the orders in the set of to-be-processed orders, and performing order processing according to the determined processing sequence, comprises:
determining a target attribute of a preceding order set of each order in the set of to-be-processed orders, wherein the target attribute is used for indicating whether the preceding order set is empty; and
determining, based on the target attribute of the preceding order set of each order and the backlog influence degree of each order, a processing sequence of each order, wherein an order having an empty preceding order set is processed earlier than an order having a non-empty preceding order set, and an order having a high backlog influence degree is processed earlier than an order having a low backlog influence degree.

16. The apparatus according to claim 15, wherein the determining, based on the backlog influence degrees, the processing sequence of the orders in the set of to-be-processed orders, and performing order processing according to the determined processing sequence, comprises:
selecting an order having an empty preceding order set from the set of to-be-processed orders and adding the selected order to an order processing queue, and performing processing steps as follows:
in response to determining that the order processing queue is non-empty and there is a current idle thread, selecting an order having the highest backlog influence degree from the order processing queue as a candidate order, processing the candidate order using the idle thread, and deleting the candidate order from the order processing queue;
releasing the occupied thread in response to determining that the processing of the candidate order is completed, and deleting an association relationship between the candidate order and the orders in the succeeding order set of the candidate order; and
updating, in response to determining that the set of to-be-processed orders comprises an unprocessed order, the order processing queue to continue to perform the processing steps.

17. The non-transitory computer readable storage medium according to claim 10, wherein a backlog influence degree of an order in the set of to-be-processed orders is used for characterizing a number of associated orders of the order in the set of to-be-processed orders, wherein service contents in an associated order of the order and service contents in a non-associated order of the order in the set of to-be-processed orders have no intersection.

18. The non-transitory computer readable storage medium according to claim 17, wherein the operations further comprise:
for each order in the set of to-be-processed orders, determining, based on the content association information, a preceding order set and a succeeding order set of the order, wherein the order, orders in the preceding order set, and orders in the succeeding order set have the same service content, respectively, and the order is generated no earlier than the orders in the preceding order set and no later than the orders in the succeeding order set.

19. The non-transitory computer readable storage medium according to claim 18, wherein the determining, based on the content association information, the preceding order set and the succeeding order set of the order, comprises:
determining, from orders that are generated no later than the order in the set of to-be-processed orders, a target order corresponding to each service content in the order to obtain a target order set, wherein a target order corresponding to a service content is an order comprising the service content and has the latest generation time;
determining, for each service content in the order, whether the target order set comprises the target order corresponding to the service content; and
in response to determining that the target order set comprises the target order corresponding to the service content, adding the target order corresponding to the service content to the preceding order set of the order, and adding the order to a succeeding order set of the target order corresponding to the service content.

20. The non-transitory computer readable storage medium according to claim 18, wherein the respectively determining, based on the content association information, the backlog influence degrees of the orders in the set of to-be-processed orders, comprises:
setting a same initial backlog influence degree for the orders in the set of to-be-processed orders;
selecting, from the set of to-be-processed orders, an order having the latest generation time as the target order, and performing update steps as follows:
determining a sum of a current backlog influence degree and the initial backlog influence degree of the target order as a comparison value, and performing update sub-steps as follows:
selecting an order from the preceding order set of the target order as a to-be-updated order, selecting a maximum value from the current backlog influence degree of the to-be-updated order and the comparison value, and updating the current backlog influence degree of the to-be-updated order using the selected maximum value;
determining whether there is an unselected order in the preceding order set;
selecting, in response to determining that there is an unselected order in the preceding order set, the unselected order from the preceding order set to continue to perform the update sub-steps; and
deleting, in response to determining that there is no unselected order in the preceding order set, the target order from the set of to-be-processed orders, and re-selecting an order having the latest generation time from the updated set of to-be-processed orders as the target order to continue to perform the update steps.
